(19) United States
(12) Patent Application Publication
(10) Pub. No.: US 2012/0209897 A1
(43) Pub. Date: Aug. 16, 2012

(54) DISC IMAGE FILE MANAGEMENT SYSTEM AND DISC IMAGE FILE MANAGEMENT METHOD

(75) Inventors: RU-CAN LI, Shenzhen City (CN); HSU-WEI CHENG, Tu-Cheng (TW); JIA-CAI PENG, Shenzhen City (CN)

(73) Assignees: HON HAI PRECISION INDUSTRY CO., LTD., Tu-Cheng (TW); HONG FU JIN PRECISION INDUSTRY (ShenZhen)., LTD., Shenzhen City (CN)

(21) Appl. No.: 13/152,263

(22) Filed: Jun. 2, 2011

(30) Foreign Application Priority Data
Feb. 11, 2011 (CN) 201110036239.0

(51) Int. Cl. G06F 17/30

(52) U.S. Cl. 707/827; 707/E17.01

(57) ABSTRACT

A disc image file management system and a disc image file method are provided. Disc image files stored in a disc image file server are transmitted from the disc image file server to a product line server according to a product schedule stored in the disc image file server. The product schedule file records time schedules for the disc image files to be transmitted to the product line server. The product line server determines whether a needed disc image file exists in the product line server, and requests the disc image file server to transmit the needed disc image file to the product line server if the needed disc image file does not exist in the product line server. The product line server transmits the needed disc image file to the client if the needed disc image file exists in the product line server.

### BACKGROUND

1. Technical Field

The present disclosure relates to a disc image file management system and method for disc image file management.

2. Description of Related Art

A known disc image file management system includes a number of product line servers and clients. Each server stores a variety of disc image files. Each server can receive a request for a needed disc image file from a corresponding client and transmit the needed disc image file to the corresponding client if the needed disc image file exists in the server. A problem with the disc image file management system is that the disc image files in each server are copied from optical discs with the disc image files manually, which may be a waste of manpower. Furthermore, during manufacturing, if a needed disc image file does not exist in the corresponding server, an optical disc with the needed disc image file has to be found, and then the needed disc image file is loaded into the server, which requires manpower and wait time. Another problem is that when the available storage capacity of the server is not enough, the system cannot automatically delete the disc image files which may no longer be needed to free up space.

### BRIEF DESCRIPTION OF THE DRAWINGS

The components of the drawings are not necessarily drawn to scale, the emphasis instead being placed upon clearly illustrating the principles of a disc image file management system and a disc image file management method. Moreover, in the drawings, like reference numerals designate corresponding parts throughout several views.

FIG. 1 is a block diagram of a disc image file management system in accordance with an exemplary embodiment.

FIG. 2 is a flowchart of a disc image file management method in accordance with an exemplary embodiment.

### DETAILED DESCRIPTION

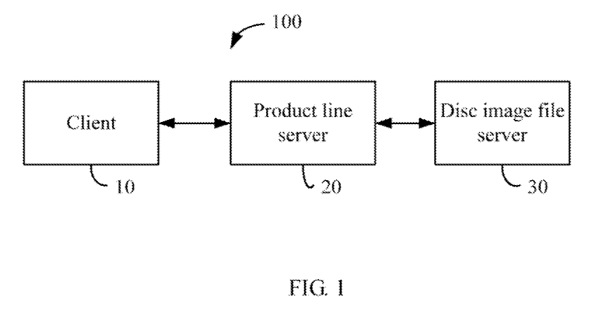

Referring to FIG. 1, a disc image file management system 100 includes at least one client 10, at least one product line server 20, and a disc image file server 30. For simplicity, one client 10 and one server 20 are employed to illustrate the present disclosure.

The server 30 stores a variety of disc image files and a product schedule. The product schedule records time schedules for the disc image files stored in the server 30 to be transmitted to the server 20. The sever 30 automatically transmits the disc image files to the server 20 according to the product schedule. In this embodiment, the server 30 is connected to the server 20 through a network such as the Internet. The server 30 monitors network traffic and controls data transmission traffic according to the network traffic to ensure that the disc image files can be successfully transmitted to the server 20. The server 30 further checks integrity of data transmission during transmitting the disc image files to the server 20.

The server 30 further stores an inventory of the server 20. The inventory includes the storage capacity of the server 20, and the file name and the file size of each of the disc image files stored in the server 20. The server 30 synchronizes the inventory with the server 20 whenever the server 20 undergoes a change, such as when one or more disc image files are added to or deleted from the server 20. The server 30 determines the available storage capacity of the server 20 according to the inventory. When the server 30 determines that the available storage capacity of the server 20 is below a predetermined capacity, the server 30 transmits a delete command to the server 20 to direct the server 20 to delete some of the disc image files from the server 20 according to use frequencies of the disc image files. The disc image file used less may be deleted. In an alternative embodiment, the server 20 determines whether its available storage capacity is not enough by itself. When the server 20 determines that its available storage capacity is below the predetermined capacity, the server 20 deletes some of the disc image files according to use frequencies of the disc image files.

In this embodiment, when the server 20 receives a request for a needed disc image file from the client 10, the server 20 determines whether the needed disc image file exists in the server 20. If the needed disc image file exists in the server 20, the server 20 transmits the disc image file to the client 10. If the disc image file does not exist in the server 20, the server 20 requests the server 30 to transmit the disc image file to the server 20. The server 20 transmits the disc image file to the client 10 when the server 30 finishes transmitting the disc image file to the server 20. In an alternative embodiment, the server 20 transmits already obtained data of the disc image file to the client 10 while the server 30 is being transmitting the disc image file to the server 20.

With such configuration, the server 30 can automatically transmit the disc image files to the server 20 according to a product schedule. Furthermore, if a needed disc image file does not exist in the server 20, the server 20 can request the server 30 to transmit the disc image file to the server 20, and then the server 20 automatically transmits the disc image file to the client 10. Thus, manpower is not needed and product efficiency correspondingly increases.

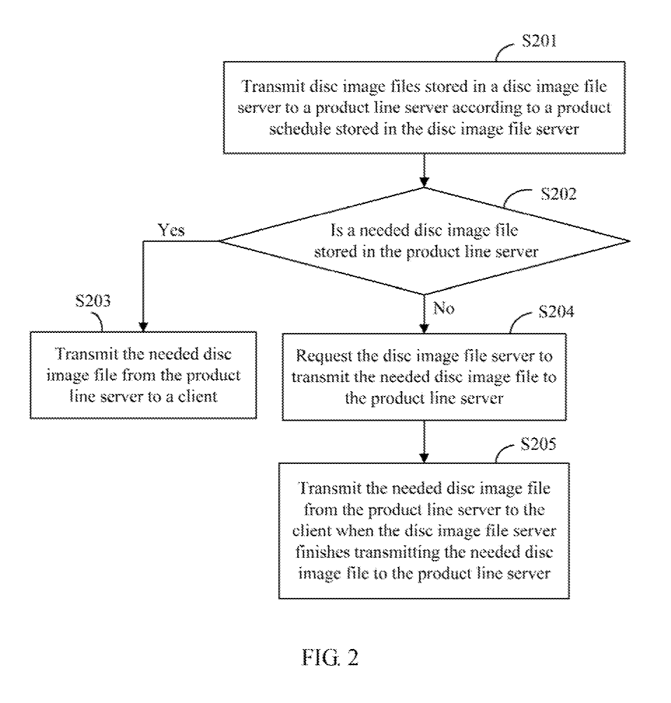

FIG. 2 is a flowchart of a disc image file management method in accordance with an exemplary embodiment.

In step S201, the server 30 transmits the disc image files to the server 20 according to the product schedule.

In step S202, the server 20 receives a request for a needed disc image file from the client 10 and determines whether the disc image file exists in the server 20. If yes, the procedure goes to step S203, otherwise, the procedure goes to step S204.

In step S203, the server 20 transmits the disc image file to the client 10.

In step S204, the server 20 requests the server 30 to transmit the disc image file to the server 20.

In step S205, the server 20 automatically transmits the disc image file to the client 10 when the server 30 finishes transmitting the requested disc image file to the server 20. In an alternative embodiment, the server 20 transmits already obtained data of the disc image file to the client 10 while the server 30 is being transmitting the disc image file to the server 20.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. A disc image file management system comprising:
a client;
a product line server; and
a disc image file server storing a plurality of disc image files and a product schedule, the product schedule recording time schedules for the disc image files to be transmitted to the product line server, the disc image file server being to automatically transmit the disc image files to the product line server according to the product schedule;
the product line server to receive a request for a needed disc image file from the client and transmit the needed disc image file to the client if the needed disc image file exists in the product line server, and further to request the disc image server to transmit the needed disc image file to the product line server if the needed disc image file does not exist in the product line server.

2. The disc image file management system as described in claim 1, wherein the disc image file server further stores an inventory recording a storage capacity of the product line server, the file name and the file size of each of the disc image files stored in the product line server, the disc image file server is further to synchronize the inventory with the product line server whenever the product line server undergoes a change, the disc image file server is further to determine the available storage capacity of the product line server according to the inventory, and transmit a delete command to the product line server to direct the product line server to delete some of the disc image files from the product line server according to use frequencies of the disc image files when the disc image file server determines that the available storage capacity of the product line server is below a predetermined capacity.

3. The disc image file management system as described in claim 1, wherein the product line server is further to delete some of its disc image files from the product line server according to use frequencies of the disc image files when the product line server determines that its available storage capacity is below a predetermined capacity.

4. The disc image file management system as described in claim 1, wherein the product line server is further to transmit the needed disc image file to the client when the disc image file server finishes transmitting the needed disc image file to the product line server.

5. The disc image file management system as described in claim 1, wherein the product line server is further to transmit already obtained data of the needed disc image file to the client while the disc image file server is being transmitting the needed disc image file to the product line server.

6. The disc image file management system as described in claim 1, wherein the disc image file server is connected to the product line server via a network, the disc image file server is further to monitor network traffic and control data transmission traffic according to the network traffic.

7. The disc image file server as described in claim 1, wherein the disc image file server is further to check integrity of data transmission during transmitting the disc image files to the product line server.

8. A disc image file management method comprising:
automatically transmitting disc image files stored in a disc image file server to a product line server according to a product schedule stored in the disc image file server, wherein the product schedule records time schedules for the disc image files to be transmitted to the disc image file server;
receiving a request for a needed disc image file and determining whether the needed disc image file exists in the product line server; and
requesting the disc image file server to transmit the needed disc image file from the disc image file server to the product line server if the needed disc image file does not exist in the product line server; and
transmitting the needed disc image file to the client if the needed disc image file exists in the product line server.

9. The disc image file management method as described in claim 8, further comprising:
automatically transmitting the needed disc image file from the product line server to the client when the disc image file server finishes transmitting the needed disc image file to the product line server.

10. The disc image file management method as described in claim 8, further comprising:
automatically transmitting already obtained data of the needed disc image file from the product line server to the client while the disc image file server is being transmitting the needed disc image file to the product line server
